(19) United States
(12) Patent Application Publication
(10) Pub. No.: US 2008/0001514 A1
(43) Pub. Date: Jan. 3, 2008

(54) Electrodes

(75) Inventors: David Steven Barratt, Blackburn (GB); Derek John Holden, Blackburn (GB); Daniel Den Engelsen, Eindhoven (NL)

Correspondence Address: BLACKWELL SANDERS LLP, 720 OLIVE STREET, SUITE 2400, ST. LOUIS, MO, 63101, US

(73) Assignee: BLACKBURN MICROTECH SOLUTIONS LIMITED, Lancashire (GB)

(21) Appl. No.: 11/720,030

(22) PCT Filed: Nov. 18, 2005
(86) PCT No.: PCT/GB05/04433

§ 371 Date: Jun. 29, 2007

(30) Foreign Application Priority Data
Nov. 24, 2004 (GB) 0425791.1

(51) Int. Cl. H01J 61/09; H01J 9/50

(52) U.S. Cl. 313/356; 445/46

(57) ABSTRACT

There is provided an electrode apparatus (1) comprising an emission source component (12) and a reservoir (4) of active material for replenishing active material of an emission surface of the source component (12) and/or for providing active material to the source component (12). Also provided are electrode assemblies, electrical apparatus comprising these and methods of manufacturing them.

### FIELD OF THE INVENTION

The present invention relates to electrode apparatus and assemblies and to electrical apparatus comprising these as well as to methods of manufacturing them.

### BACKGROUND TO THE INVENTION

There are known electrodes having a range of constructions and applications. Cold cathode electrodes for example have been found effective for lighting applications including cold cathode fluorescent lamps (CCFL) as backlights for LCD displays.

Known electrodes may comprise a tubular body which is blind at one end comprising an emission material, such as Molybdenum, and to which a stem (or pin) is attached.

A known problem with electrodes is that sputtering can erode the surface and thin the walls of the electrode. Thus, the lifespan of electrode wall or of a surface coating provided thereto may be limited.

There thus remains a need for alternative electrodes and manufacturing methods.

Accordingly, the present invention aims to address at least one disadvantage associated with the prior art whether discussed herein or otherwise.

### SUMMARY OF THE INVENTION

According to a first aspect of the present invention there is provided an electrode apparatus comprising an emission source component having an emission surface comprising an active material and/or arranged to receive an active material and wherein the electrode apparatus further comprises a reservoir of active material for replenishing the active material of said source component emission surface and/or for providing an active material to said source component emission surface.

Preferably, the electrode apparatus comprises an emission source component having an emission surface comprising an active material and wherein the electrode apparatus further comprises a reservoir of active material for replenishing the active material of said source component emission surface.

Preferably, the electrode apparatus comprises an emission source component comprising a tubular wall providing a hollow tubular body and having an inner emission surface comprising an active material and wherein the electrode apparatus further comprises a reservoir of active material for replenishing the active material of the tubular wall emission surface.

Suitably, the active material of the emission surface, preferably of the tubular wall inner surface, provides an electron source.

Suitably, the active material of the reservoir and the active material of the emission surface, preferably of the tubular wall inner surface, are substantially the same.

Suitably, the reservoir is located at an end of the tubular body.

Suitably, at least part of the reservoir is located within the tubular body.

The reservoir may be arranged to close an end of the tubular body such that the tubular body is blind at one end.

Alternatively, the reservoir may be arranged to partially obstruct an opening at the end of the tubular body but not fully close it such that the body is open at opposed ends.

Suitably, the reservoir is arranged such that, in use, sputtering causes active material to be released from the reservoir such that it can deposit on the emission source surface, preferably on the inner surface of the tubular wall. Active material from the reservoir may thus deposit on the tubular wall to replenish active material at the emission source surface which has itself been depleted by sputtering.

In one embodiment the emission source component is manufactured with an emission surface which does not comprise an active material. Active material from the reservoir may then be caused to be provided to the emission surface in use in a lamp during “normal” operation and/or during a pre-processing operation once an electrode is sealed in a lamp but before “normal” operation.

In this arrangement rather than coating the emission surface of the source component separately, the apparatus may be arranged such that sputtering at the reservoir allows the reservoir to provide the initial coating to the emission surface as well as to replenish the coating in use.

If the initial coating is to be provided in “normal” use the components may be dimensioned to ensure sputtering takes place at the reservoir.

If the initial coating is to be provided in a pre-processing operation then different AC frequencies and/or higher voltages and/or higher gas pressures may be used in the lamp during that operation to ensure sputtering and coating occurs.

The active material may comprise a metal having a high activity and may have improved electron emission properties in comparison to other metals which may be due to the metal having a lower work function and/or higher electrical conductivity. Suitably, the active material comprises a low work function material.

The active material may comprise one or more of Molybdenum, Tungsten, Barium, Aluminium, Barium-Aluminium alloy or other suitable elements or alloys. The active material preferably comprises Barium and/or Aluminium. Suitably, the active material comprises a Barium-Aluminium alloy. The active material suitably comprises alloys which are high in Barium and/or Aluminium, said alloys may further comprise Molybdenum and/or Nickel.

The active material may comprise an alloy comprising Mercury. Suitably, the active material comprises an alloy comprising Barium, for example Barium-Aluminium, and Mercury. The active material may comprise a Ba—Al and Hg alloy. The inclusion of Mercury may, in use, counteract difficulties associated with the removal of Mercury (Hg) vapour within a lamp by reaction with Barium (Ba). Thus, the use of such an alloy may improve lamp brightness and/or efficiency.

The active material may comprise a Metal Oxide, preferably a Barium and/or Aluminium Oxide. The active material may comprise a Barium Oxide produced by oxidising a Barium Carbonate. The active material may thus comprise a coating on a base material formed by applying a carbonate and subjecting the electrode apparatus to a pre-processing operation to oxidise the carbonate to an oxide.

Suitably, the active material of the emission source component emission surface, preferably of the tubular wall surface, is applied as a coating to a carrier base metal and comprises a metal which has a higher activity than the metal that it coats.

Suitably, the reservoir of active material is carried upon a carrier base metal and comprises a metal which has a higher activity than said base metal.

Suitably, the tubular body has an outer diameter of between 0.5 and 5 mm.

Suitably, the tubular body has a length of between 1 and 20 times its diameter, preferably between 3 and 15 times its diameter, for example around 10 times its diameter.

Suitably, the length of the tubular body is at least 5 times its diameter, for example at least 6, 7, 8, 9, 10, 11 or 12 times its diameter.

Suitably, the tubular body comprises an open ended tube provided by the tubular wall.

The apparatus suitably comprises a closure member arranged to close an end of the tube. The tubular wall may thus comprise a side wall of the tubular body and the closure member may comprise a closure (base) wall of the tubular body.

Suitably, the reservoir comprises a closure member arranged to close an end of the tubular body such that the tubular body is blind at one end.

Alternatively, the apparatus may comprise a carrier member comprising the reservoir. The carrier member may be arranged to obstruct but not fully close an end of the tubular body.

Alternatively, the tubular body may be blind at one end and comprise a deep-drawn body. The tubular wall may thus comprise a section of a wall which also comprises a closure (base) wall section.

The electron emission source component may further comprise a stem. The stem may be connected to the closure member and may be formed integrally therewith. Alternatively, the stem may be connected to the tubular wall. The stem may comprise a glass ring by which the component may be secured to a housing. Suitably, the stem is arranged to connect to a power supply such that the electrode apparatus comprises an electrode.

Alternatively, a part of the tubular wall of the component may comprise a glass ring around its outer side by which the component may be secured to a housing. The component may also comprise a glass wall located internal of the tubular body provided by the tubular wall. The tubular wall of the component may be arranged, to connect to a power supply such that the electrode apparatus comprises a stemless electrode.

Suitably, the apparatus comprises a closure member which comprises the reservoir of active material and is arranged such that the reservoir forms an internal surface of the tubular body.

The closure member may comprise a wall comprising a base material which carries a quantity of active reservoir material. Alternatively, the closure member may comprise a wall which comprises the active reservoir material.

The closure member may comprise a closure wall formed from a base material and which carries a piece of active material to provide said reservoir. Preferably, the reservoir comprises a coating of active material applied to a base material of a closure wall of the closure member. Suitably, said coating has a thickness of between 0.001 mm and 1 mm, preferably between 0.01 mm and 0.5 mm.

The closure wall is suitable arranged to close an end of a tube.

Alternatively, the apparatus may comprise a carrier member which comprises the reservoir of active material and which is arranged such that the reservoir lies internal to the tubular body.

The carrier member may comprises a wall comprising a base material which carries a quantity of active reservoir material. Alternatively, the carrier member may comprise a wall which comprises the active reservoir material.

The carrier member may comprise a carrier wall formed from a base material and which carries a piece of active material to provide said reservoir. Preferably, the reservoir comprises a coating of active material applied to a base material of a carrier wall of the carrier member. Suitably, said coating has a thickness of between 0.001 mm and 1 mm, preferably between 0.01 mm and 0.5 mm.

The carrier wall is suitably arranged to obstruct but not fully close an end of a tube.

The tubular wall of the electrode apparatus may comprise a base material which has a surface coated with active material to form the inner surface of the wall. The surface coating may have a thickness of between 0.001 mm and 0.1 mm. Alternatively, the tubular wall may comprise the active material which forms the inner surface of the tubular wall.

Suitably, the tubular wall comprises a metal sheet. The metal sheet may comprise said base material of the tubular wall. The metal sheet may be rolled into a tubular configuration. Suitably, the metal sheet is bent into a tubular configuration.

Suitably, the tubular wall comprises a pure metal. Alternatively, the tubular wall may comprise an alloy.

Suitably, the tubular wall has a melting point of greater than 1100° C. Suitably, the tubular wall has a thermal conductivity of between 0.2 Watts/cm².° C. and 5.0 Watts/cm².° C. Suitably, the tubular wall has a coefficient of linear expansion of between 1×10⁻⁶/° C. and 30×10⁻⁶/° C. at ambient temperature.

Suitably, the tubular wall comprises a transition metal. Suitably, the tubular wall comprises a base material selected from the group consisting of Steel (ferrous) alloys such as Kovar, Nickel (Ni), refractory metals such as Molybdenum (Mo), Niobium (Nb), Tantalum (Ta) and Tungsten (W) or alloys and/or mixtures thereof and which is coated with said active material. Alternatively, the tubular wall may be formed solely from said active material.

The tubular wall may comprise a metal sheet which is provided with a surface coating of an active material on a first side and then formed into a tube such that said first side forms the inner face of the tube. Thus, it may be possible to form a tubular body having a tube of substantial length which is coated substantially evenly over its inner extent.

The surface coating of active material on the tubular wall may be arranged to improve the performance and/or lifespan of the electrode apparatus.

The surface coating of active material on the tubular wall may comprise micro and/or nano sized particles to increase the surface area of the electrode apparatus. This may result in higher brightness and/or lower operating temperatures for lamps employing electrodes comprising the electron emission source component.

The surface coating of active material on the tubular wall may comprise a metal which has a higher activity than the metal forming the component that it coats. A metal having a higher activity may have improved electron emission properties which may be due to the metal having a lower work function and/or higher electrical conductivity.

The surface coating may comprise Molybdenum, Tungsten, Barium, Aluminium, Barium-Aluminium alloy or other suitable elements or alloys. The electrode apparatus may thus be constructed from a tubular wall comprising a metal, such as Nickel, coated with a more active but more expensive metal, such as Molybdenum, Tungsten, Barium, Aluminium or Barium-Aluminium alloy. This may allow effective electrodes to be manufactured more economically. The surface coating may comprise an alloy comprising Barium, for example Barium-Aluminium, and Mercury.

A coating of active material may be applied to a part of an electrode apparatus by a number of known methods, for example any of sputter coating, electrochemical deposition, metal-organic vapour phase deposition, in-situ precipitation, sol-gel processes, spraying, brushing or coil coating may be suitable. The coating may be provided as a carbonate and subsequently converted to an oxide.

Suitably, the metal sheet has a thickness of between 0.01 and 0.1 mm, preferably between 0.02 and 0.1 mm, for example around 0.08 mm. The tube may thus have a wall having a thickness of between 0.01 and 0.1 mm, preferably between 0.02 and 0.1 mm, for example around 0.08 mm. The wall may have double this thickness where edges of the metal sheet overlap.

Suitably, the tube has a substantially circular cross section.

Suitably, the tube comprises a bent metal sheet which is substantially planar prior to being formed into the tube.

Suitably, the tube comprises a bent metal sheet which is substantially rectangular prior to being formed into the tube.

Suitably, opposed first and second edges of the metal sheet lie substantially adjacent one another when formed into the tube.

Suitably, first and second edge regions of the metal sheet overlap when formed into the tube. The tube may thus have a double wall thickness at a seam which closes the tube circumferentially.

Suitably, the first and second edge regions of the metal sheet overlap by between 0.1% and 10% of the circumference of the tube, for example by between 0.5% and 8%.

Suitably, the tube is secured to the closure member by one or more welds. Suitably, the tube and closure member are laser welded together. Suitably, the welds are spot welds.

Suitably, the closure member comprises a closure member secured to the tube by a first weld located at a region in which the first and second edges of the metal sheet overlap and in which the closure member and tube overlap. The closure member and tube may be secured by one or more further welds, preferably by two further welds spaced between 9° and 150 degrees, for example around 120 degrees, either side of the first weld.

Alternatively, a carrier member may be located such that a part obstructs an open end of the tube without contacting the tube and/or being directly attached to the tube. Suitably, the carrier member is indirectly attached to the tube. The carrier member may be attached to the tube via a glass wall lying internal to the tube.

The closure member or carrier member may comprise a pure metal. Alternatively, the closure/carrier member may comprise an alloy.

Suitably, the closure/carrier member has a melting point of greater than 1100° C. Suitably, the closure/carrier member has a thermal conductivity of between 0.2 Watts/cm².° C. and 5.0 Watts/cm².° C. Suitably, the closure/carrier member has a coefficient of linear expansion of between 1×10⁻⁶/° C. and 30×10⁻⁶/° C. at ambient temperature.

Suitably, the closure/carrier member comprises a transition metal. Suitably, the closure member comprises a wall comprising a base material selected from the group consisting of Steel (ferrous) alloys such as Kovar, Nickel (Ni), refractory metals such as Molybdenum (Mo), Niobium (Nb), Tantalum (Ta) and Tungsten (W) or alloys and/or mixtures thereof and which carries said active reservoir material. Alternatively, the closure member may comprise a wall formed solely from said active reservoir material.

The surface coating of active material forming the reservoir on the closure/carrier member may comprise a metal which has a higher activity than the metal forming the component that it coats. A metal having a higher activity may have improved electron emission properties which may be due to the metal having a lower work function and/or higher electrical conductivity. The surface coating may comprise Molybdenum, Tungsten, Barium, Aluminium, Barium-Aluminium alloy or other suitable elements or alloys. The electrode apparatus may thus be constructed from a closure/carrier member comprising a metal, such as Nickel, coated with a reservoir of more active but more expensive metal, such as Molybdenum, Tungsten, Barium, Aluminium, or Barium-Aluminium alloy. This may allow effective electrodes to be manufactured more economically. The surface coating may comprise an alloy comprising Barium, for example Barium-Aluminium, and Mercury.

The closure/carrier member and tubular wall may comprise the same metal. Alternatively, the closure/carrier member and tubular wall may comprise distinct metals. The tubular wall and closure/carrier member may thus be made from distinct materials chosen for their specific properties and functional performance in the overall electrode apparatus combination.

The closure/carrier member may comprise a cap. Suitably, the apparatus comprises a closure member comprising a cap arranged to locate over the tubular wall. Alternatively, the apparatus may comprise a closure/carrier member comprising a plug arranged to locate within the tubular wall. Suitably, the apparatus comprises a closure member comprising a plug.

The closure member may comprise a cap comprising an active reservoir material. Suitably, the closure member comprises a cap comprising a base material carrying an active reservoir material. Suitably, the active reservoir material comprises a coating applied to an inner surface of the cap. Suitably, the coating is applied to a closure wall of the closure member which is arranged to provide the inner face of the blind end of the tubular body.

Suitably, the cap comprises a tube which is blind at one end and open at the other. Suitably the blind end of the tube comprises a closure wall of the closure member. Suitably, the cap is formed by deep-drawing.

The cap may comprise a stem connected to the closure wall. The closure wall and stem may be integral. Alternatively, the closure wall may be arranged to be connected to a stem.

Suitably, the cap has walls having a thickness of between 0.01 and 0.1 mm, preferably between 0.02 and 0.1 mm, for example around 0.055 mm.

Suitably, the cap is arranged to hold a bent metal sheet forming the tubular wall in a tubular configuration. Suitably, the cap is arranged to locate over an end of the tube such that the tube fits snugly therein.

Suitably, the cap is located over the tube such that the cap overlaps an end region of the tube by between 0.1 and 30% of the tube length, preferably by between 0.5 and 20% of the tube length, for example by between 2 and 15% of the tube length.

Suitably, the cap overlaps the tube by between 0.1 mm and 10 mm. Suitably, the cap overlaps the tube by at least 0.1 mm, preferably by at least 0.3 mm, for example by at least 0.5 mm.

The overlap of the cap and tube may be arranged to provide an electrode apparatus having a double wall thickness at a region which may be prone to develop holes when the component is employed in an electrode.

The closure member may comprise a plug comprising an active reservoir material. Suitably, the closure member comprises a plug comprising a base material carrying an active reservoir material. Suitably, the active reservoir material comprises a coating applied to a surface of the plug which lies internal of the tubular body. Suitably, the coating is applied to a closure wall of the closure member which is arranged to provide the inner face of the blind end of the tubular body.

Suitably, the plug comprises a head portion. Suitably, the head portion comprises the closure wall and suitably carries the active reservoir material.

The plug may comprise a stem connected to the head portion. Alternatively, the plug may comprise a head portion arranged to be connected to a stem.

Suitably, the plug comprises a head connected to the stem such that the two have a substantially T-shaped cross section. The plug and stem may comprise a unitary body.

The plug may be formed by casting. Alternatively, it may be formed by a drawing process if appropriate or the head may be pressed and the stem may be cut from a rod.

The head portion may be welded to a stem. Alternatively, the head portion may be provided with an aperture into which a stem can be inserted. The head portion may comprise a disc having an aperture and may thus comprise a washer. Suitably, the stem diameter is slightly greater than the diameter of the head portion aperture. The stem may thus be a forced fit into the head portion aperture.

The stem may be welded to the head portion such that recrystallisation of the plug components occurs. This may increase the rate of sputtering and thus improve the performance of the reservoir.

Suitably, the head portion comprises a disc which may be substantially circular. Suitably, the disc has a diameter arranged such that it fits snugly within the tube.

The disc may have a diameter of between 0.45 to 4.98 mm. Suitably, the disc has a thickness of between 0.01 and 10 mm, preferably between 0.01 to 1 mm, more preferably between 0.02 and 1 mm, for example 0.5 mm.

Suitably, the tube is located over the plug such that the tube overlaps the head portion by between 0.1 and 30% of the tube length, preferably by between 0.5 and 20% of the tube length, for example by between 2 and 15% of the tube length.

Suitably, the tube overlaps the plug by between 0.1 mm and 10 mm. Suitably, the cap overlaps the tube by at least 0.1 mm, preferably by at least 0.3 mm, for example by at least 0.5 mm.

As an alternative to a closure member comprising a cap or plug the apparatus may comprise a carrier member comprising substantially the same form as a plug or cap as described herein but being sized so as to locate within the tubular body to obstruct but not fully close an end thereof.

Whether the apparatus comprises a closure member or carrier member the plug or cap and/or stem may have preferred properties.

Suitably, the plug head portion or cap and/or stem has a melting point of greater than 1100° C. Suitably, the plug head portion or cap and/or stem has a thermal conductivity of between 0.2 Watts/cm2.° C. and 5.0 Watts/cm2.° C. Suitably, the plug head portion or cap and/or stem has a coefficient of linear expansion of between 1×10⁻⁶/° C. and 30×10⁻⁶/° C. at ambient temperature.

Suitably, the plug head portion or cap and/or stem comprises a transition metal. Suitably, the plug head portion or cap and/or stem comprises a metal selected from the group consisting of Steel (ferrous) alloys such as Kovar, refractory metals such as Nickel (Ni), Molybdenum (Mo), Niobium (Nb), Tantalum (Ta) and Tungsten (W) or alloys and/or mixtures thereof.

Suitably, the plug head portion or cap and tube comprise the same metal. Alternatively, the plug head portion or cap and tube comprise distinct metals. The tube and plug head portion or cap may thus be made from distinct materials chosen for their specific properties and functional performance in the overall electrode apparatus combination.

Suitably, the plug head portion or cap and stem comprise the same metal. Alternatively, the plug head portion or cap and stem comprise distinct metals. The stem and plug head portion or cap may thus be made from distinct materials chosen for their specific properties and functional performance in the overall electrode apparatus combination.

According to a second aspect of the present invention there is provided an electrode assembly comprising an electrode apparatus comprising an emission source component having an emission surface comprising an active material and/or arranged to receive an active material and wherein the electrode apparatus further comprises a reservoir of active material for replenishing the active material of said source component emission surface and/or for providing active material to said source component emission surface and a stem connected to the source component.

Preferably, the electrode assembly comprises an electrode apparatus comprising an emission source component having an emission surface comprising an active material and wherein the electrode apparatus further comprises a reservoir of active material for replenishing the active material of said source component emission surface and a stem connected to the source component.

Preferably, the electrode assembly comprises an electrode apparatus comprising an emission source component comprising a tubular wall providing a hollow tubular body and having an inner emission surface comprising an active material and wherein the electrode apparatus further comprises a reservoir of active material for replenishing the active material of the tubular wall emission surface and a stem connected to the tubular body.

Suitably, the tubular body is blind at one end and the stem is attached to that end. Suitably, the blind end of the tubular body comprises the reservoir.

Suitably, the tubular body comprises a closure member to which the stem is attached.

The stem may be formed integrally with the closure member. Alternatively, the stem may be connected to the closure member. The stem may be welded to the closure member and/or connected to the closure member by means of a forced fit.

Alternatively, the stem may be connected to the tubular wall.

Suitably the stem extends substantially parallel to the axis of the tube. Suitably, the tube and stem have a substantially common axis.

Suitably, the electrode assembly comprises a glass ring mounted on the stem. The glass ring may provide an attachment point by which the electrode may be secured into a housing.

Suitably, the electrode assembly comprises an electrode apparatus according to the first aspect.

According to a third aspect of the present invention, there is provided an electrical apparatus comprising an electrode apparatus according to the first aspect and/or an electrode assembly according to the second aspect.

The electrical apparatus may comprise a lighting apparatus. The electrical apparatus may for example comprise a cold-cathode fluorescent lamp, used for example in a back light for an LCD display.

Suitably, the electrical apparatus comprises a housing and an electrode apparatus according to the first aspect and/or an electrode assembly according to the second aspect secured thereto.

Suitably, the electrical apparatus comprises a lamp. Suitably, the housing comprises a glass housing.

Suitably, the electrical apparatus comprises an electrode assembly according to the second aspect and a stem of the electrode assembly passes through a wall of the housing and is secured thereto such that the tubular body lies within the housing. The apparatus may thus be arranged such that it can be connected to a power supply by the stem.

Alternatively, the electrical apparatus may comprise an electrode apparatus according to the first aspect which has an open ended tubular body wherein part of the tubular wall passes through a wall of the housing and is secured thereto such that part of the tubular body lies within the housing and part lies external thereto. The apparatus may thus be arranged such that it can be connected to a power supply by the part of the tubular wall external to the housing. The electrical apparatus may thus comprise a stemless electrode.

According to a fourth aspect of the present invention, there is provided a method of forming an electrode apparatus according to the first aspect, wherein the method comprises producing a closure or carrier member comprising a reservoir of active material and forming an open ended tube comprising a tubular wall having an inner surface comprising an active material.

Suitably, the method comprises producing a closure member. Suitably, the method comprises securing the tube and a closure member to one another such that the closure member closes an end of the tube to provide a tubular body which is blind at one end.

Suitably, the method comprises forming a closure member, which may be a cap or a plug, from a base material and applying a coating of active material thereto to provide said reservoir.

Suitably, the method comprises applying a coating of active material to a metal sheet comprising a base material and bending the metal sheet to form said tube.

Suitably, the method comprises wrapping a metal sheet around a forming member such that the metal sheet adopts a tubular configuration substantially corresponding to the outer face of the forming member and then securing the closure member to the tube to form a tubular body which is blind at one end.

The forming member may comprise a forming pin of a forming apparatus and the method may comprise locating a closure member in position relative to the tube subsequent to the tube forming step. Alternatively, the closure member may comprise a plug and the forming member may comprise a head portion of said plug. The metal sheet may thus be wrapped around the head portion of the plug such that the closure member is located in position relative to the tube during the tube forming step.

Suitably, the metal sheet is wrapped around a forming member by a plurality of form fingers. The form fingers may press the metal sheet against the forming member to form the tube.

Suitably, the method comprises the step of securing the metal sheet in the tubular configuration. Said securement step may comprise welding edges of the metal sheet together in the tubular configuration.

Alternatively, or in addition, the securement step may comprise securing the tube to the closure member such that it can hold the metal sheet in the tubular configuration. The tube and closure member may be welded together.

Suitably, a stem is attached to the tubular body such that an electrode is manufactured. Suitably, the stem is attached to the blind end of the tubular body. The method may comprise attaching a stem to a closure member. Alternatively, the closure member may comprise a stem. The electrode apparatus manufactured by the method may thus comprise an electrode.

The method may further comprise manufacturing an electrode assembly according to the second aspect and/or an electrical apparatus according to the third aspect.

### BRIEF DESCRIPTION OF THE DRAWINGS

The present invention will now be illustrated by way of example with reference to the accompanying drawings in which:

FIG. 1 is a cross-section of an electrode apparatus showing hidden detail;

FIG. 2 is a perspective view of an alternative embodiment of an electrode apparatus showing hidden detail;

FIGS. 3A-3C are cross-sections of the electrode apparatus of FIG. 2 showing it at successive stages of operation;

FIG. 4 is a cross section of a cold cathode fluorescent lamp comprising the electrode apparatus of FIG. 1; and

FIG. 5 is a cross section of an alternative embodiment of a cold cathode fluorescent lamp comprising an alternative electrode apparatus.

### DESCRIPTION OF THE PREFERRED EMBODIMENTS

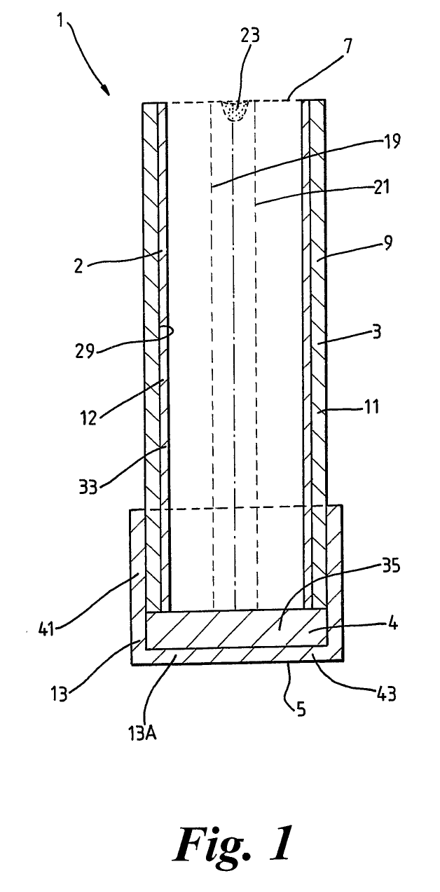

As illustrated by FIGS. 1 to 3 an electrode apparatus 1 comprises a tubular body 3 which is blind at a first end 5 and open at an opposed second end 7. The tubular body 3 comprises a tube 9 formed by a tubular wall 11 having an internal surface 29 that comprises an active material 2. The wall 11 with its surface 29 comprising active material 2 thus comprises an emission source component 12. The electrode apparatus also comprises a reservoir 4 of active material for replenishing the active material 2 of the tubular wall 11. The illustrated electrode apparatus has a length of around 3 mm and a diameter of around 1 mm.

In the illustrated embodiments the tubular body 3 of the electrode apparatus comprises a closure member 13 located at an end of the tube 9 such that the body 3 is blind at that end. The tubular wall 11 thus comprises a side wall of the electrode apparatus 1 and the closure member 13 comprises a closure (base) wall thereof.

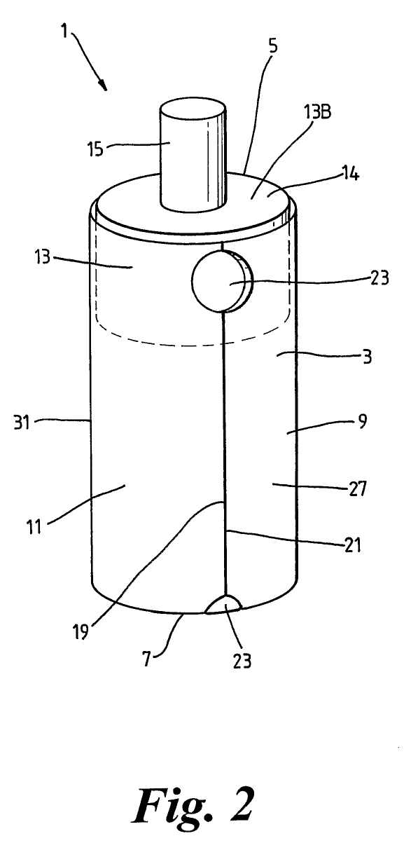

In the embodiment illustrated by FIG. 1 the closure member comprises a cap 13A arranged to locate over the end of the tube 9. In the embodiment of FIG. 2 the closure member comprises a plug 13B having a head portion 14 arranged to locate within the end of the tube 9. These are discussed in more detail later. In an alternative embodiment (not illustrated) the tubular body is formed by deep-drawing and the side and closure walls of the electrode apparatus 1 are thus integral.

The closure member 13 comprises the reservoir 4 of active material which is thus located at the blind end 5 of the tubular body 3.

The embodiments of FIGS. 1 and 2 feature a common tube 9 construction. The tube 9 is formed from a metal sheet (not shown) which is bent to create a tubular wall 11 which forms the tube 9.

The tube 9 is fabricated by wrapping a metal sheet around a forming member (not shown) to create the tubular wall 11. The metal sheet is pressed against the forming member such that it adopts a tubular configuration substantially corresponding to the outer face of the forming member.

The metal sheet is bent such that first and second edge regions 19, 21 of the tubular wall 11 overlap. A first side of the metal sheet forms an inner face 29 of the electrode apparatus 1 and a second side forms an outer face 31 thereof.

The metal sheet comprises Nickel (as a base material) which has a coating 33 of active material applied thereto. The coating is applied to the first side of the sheet such that the coating forms the inner surface 29 of the tubular wall 11.

The coating of active material comprises a Barium-Aluminium alloy and is applied only to the first side of the sheet and is applied before the sheet is formed into the tube. The coating is laid down such that the coating has a thickness of around 0.05 mm. The coating is formed by a deposition process.

In an alternative embodiment (not illustrated) the coating of active material comprises an alloy of Barium-Aluminium and Mercury.

In an alternative embodiment (not illustrated) the tubular wall is formed from active material, such as Barium-Aluminium alloy, so that the wall provides the active material and does not require coating.

FIG. 1 illustrates a first embodiment of the present invention. According to this embodiment the closure member 13 is a cap 13A. The cap 13A comprises a tubular body that is blind at one end and comprises a cylindrical wall 41 extending from a base wall 43. The electrode apparatus further comprises a stem mounted to the base wall 43 of the cap 13A.

The cap 13A comprises Nickel (as a base material) which has a coating 35 of active material applied thereto to form a reservoir 4. The coating of active material comprises a Barium-Aluminium alloy and is applied only to the inner face of the base wall 43 of the cap 13A. The coating is applied to the cap prior to the caps installation over the tube 9 and is laid down such that the reservoir 4 has a thickness of around 0.2 mm. The coating is formed by a deposition process.

In an alternative embodiment (not illustrated) the coating of active material comprises an alloy comprising Barium-Aluminium and Mercury.

In another alternative embodiment (not illustrated) the reservoir comprises a sheet of active material, such as Barium-Aluminium alloy mounted to the base wall of the cap. In a further alternative embodiment (not illustrated) the cap comprises a base wall formed from active material, such as Barium-Aluminium alloy, so that the wall serves as the reservoir and does not require coating.

Electrode apparatus formed from a tube 9 and cap 13A is produced by fabricating the respective components separately and then securing the cap 13A to the tube 9.

The tube 9 is formed as described above by wrapping a metal sheet around a forming member comprising a forming pin (not shown) to create the tubular wall 11 and the cap 13 is formed by deep-drawing. Once the cap is formed the reservoir 4 is then formed upon the base wall 43 of the cap 13A.

The electrode apparatus 1 is then produced by locating the cap 13A onto the tube 9 and laser welding the cap to the tube.

The cap 13A and tube 9 are laser welded at weld points 23 to secure the tube to the cap and to retain the metal sheet in a tubular configuration. A first weld point is located within a zone in which the cap 13A and edge regions 19, 21 of the tube 9 overlap. Two further weld points are spaced around the cap 13A within a zone which overlaps with the tube 9 such that they lie approximately 120 degrees either side of the first weld point. An additional weld point is located at the second end 7 of the tube 9 within a zone in which the edge regions 19, 21 overlap.

The stem 15 can be welded to the cap 13A once the remainder of the electrode apparatus is formed. Alternatively, the stem can be attached to the cap 13A prior to installation of the cap. In either case the electrode apparatus produced may comprise an electrode.

FIG. 2 illustrates a second embodiment of the present invention. According to this embodiment the closure member comprises a plug 13B. The plug 13B comprises a head portion 14 that comprises a circular disc and an integral stem 15. The head portion serves as a closure wall for closing an end of the tube 9. In another embodiment (not shown) the plug comprises only a head portion and a separate stem is attached thereto subsequently to create an electrode.

The plug 13B comprises Nickel (as a base material) which has a coating of active material applied thereto to form a reservoir 4. The coating 35 of active material comprises a Barium-Aluminium alloy and is applied only to the inner face of the head 14 of the plug 13B. The coating is applied to the plug prior to the plugs installation into the tube 9 and is laid down such that the reservoir 4 has a thickness of around 0.2 mm. The coating is formed by a deposition process.

In an alternative embodiment (not illustrated) the reservoir comprises a sheet of active material, such as Barium-Aluminium alloy mounted to the head of the plug. In another alternative embodiment (not illustrated) the plug comprises a head comprising a wall formed from active material, such as Barium-Aluminium alloy, so that the head serves as the reservoir and does not require coating.

Electrode apparatus formed from a tube 9 and plug 13B is produced by fabricating the respective components separately and then securing the plug 13B to the tube 9.

The plug 13B is formed by casting and formed integrally with the stem 15. Once the plug is formed the reservoir 4 is then formed upon the head 14 of the plug 13B.

The tube 9 is manufactured in a similar manner as described in relation to the embodiment of FIG. 1 with the distinction being that the head 14 of the plug 13B serves as a forming member around which the metal sheet is wrapped to form the tubular wall 11.

The electrode apparatus 1 is then formed by laser welding the tube 9 to the plug 13B. The plug 13b and tube 9 are welded at points generally corresponding to those in which the tube and cap of the first embodiment are attached.

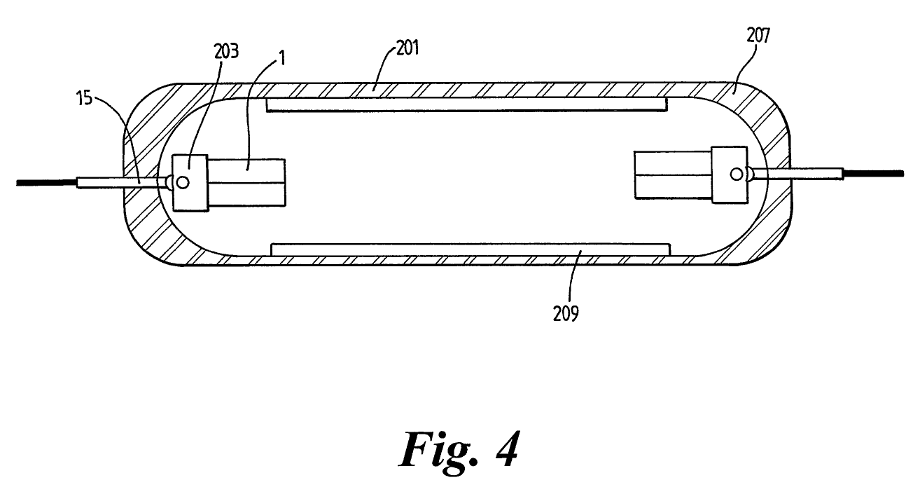

FIG. 4 illustrates a cold cathode fluorescent lamp 201 comprising electrodes 203 each comprising an article of electrode apparatus 1 including a stem 15 attached thereto. The lamp 201 comprises a glass body (housing) 207 through which the stems 15 extend. The interior of the glass body 207 is provided with a phosphor coating 209 and the body 207 is evacuated and charged with a small quantity of mercury.

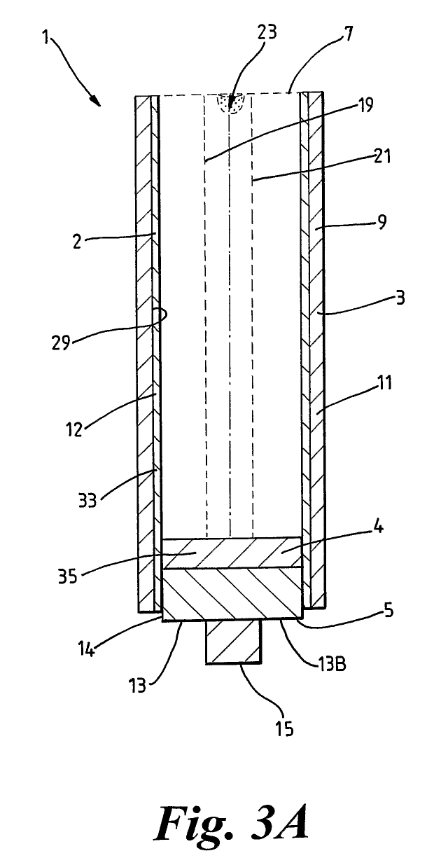

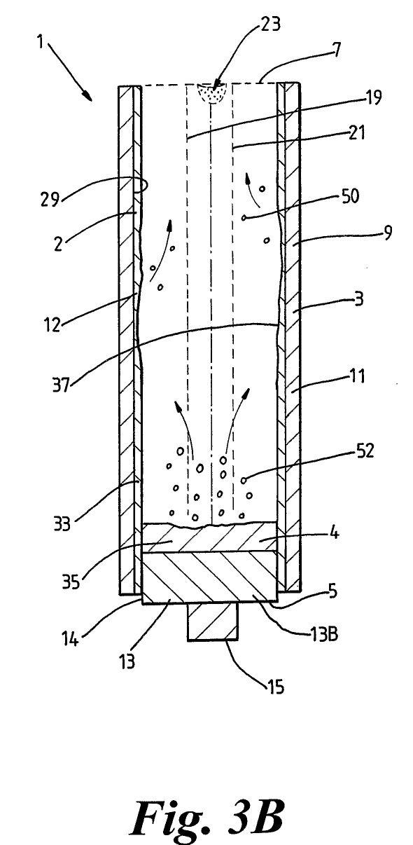

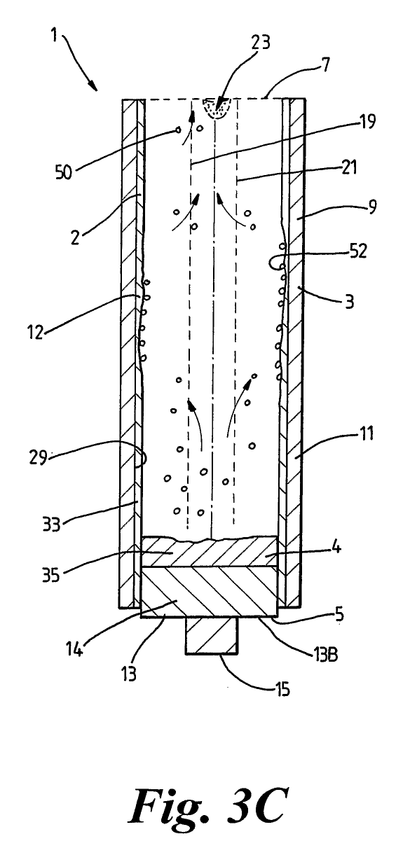

The operation of the reservoir during use of the electrode apparatus 1 is illustrated in simplified schematic form by FIGS. 3A-3C. The component 1 corresponds to that of FIG. 2 and is labelled accordingly.

FIG. 3A illustrates a new the electrode apparatus 1 having a tubular wall 11 provided with a coating 33 of active material 2 which forms the inner surface 29 of the tubular wall 11. The closure member 13 comprises a plug 13B having a head portion 14 provided with a coating 35 of active material which provides the reservoir 4.

In use, as illustrated by FIG. 3B sputtering causes the coating 33 of active material 2 on the tubular wall to erode as shown generally at region 37. This erosion comprises the release of active material 2 (illustrated by schematic particles 50) from the surface 29 of the tubular wall. This material moves toward the open end 3 of the tube 9. At the same time sputtering causes the reservoir 7 of active material 2 to erode with active material 2 (illustrated by schematic particles 52) being released from the reservoir. This material moves toward the open end 3 of the tube 9 but largely remains within the tube 9.

As shown by FIG. 3C some active material 2 (illustrated by schematic particles 52) released from the reservoir 7 deposits on the eroded regions 37 of the coating 33 on the tubular wall 11 and thus replenishes the coating 33. The tubular wall thus comprises an effective layer of active material 2 for a longer period of time than if the reservoir were not present.

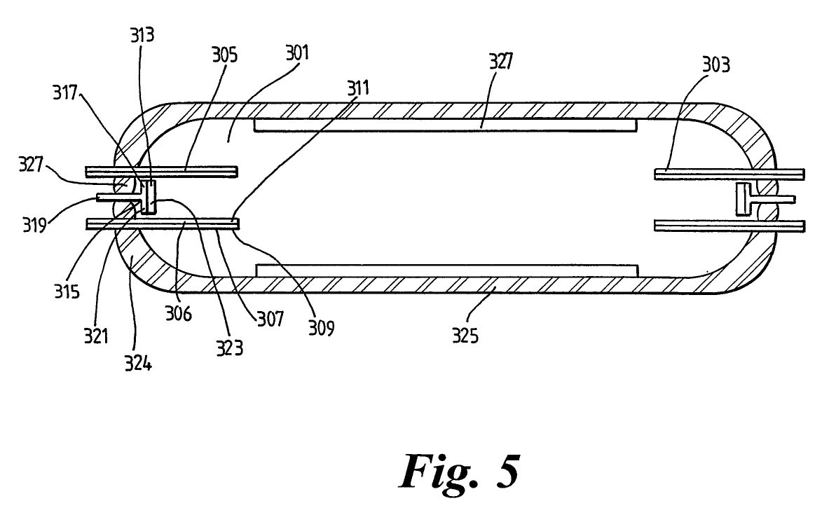

FIG. 5 illustrates an alternative embodiment of a cold cathode fluorescent lamp 301 comprising electrodes 303 at opposed ends and each of which comprises electrode apparatus 305.

The electrode apparatus 305 comprises electron emission source component 306 comprising an open ended tubular body 307 provided by a tubular wall 309. The tubular body 307 comprises a tube formed in substantially the same manner as that of the embodiments of FIGS. 1 and 2. The tubular wall 309 comprises Kovar (steel alloy) as a base material and is provided with an active material coating layer 311 of Barium-Aluminium alloy.

The electrode apparatus 305 further comprises a reservoir 313 comprising a carrier member 315 which comprises a plug having a head portion 317 and a stem 319. The head 317 comprises a carrier wall 321 which comprises Kovar (steel alloy) as a base material and is provided with an active material coating layer 323 of Barium-Aluminium alloy.

The lamp 301 is such that the electrodes 303 thereof consist of a tubular body 307 and thus comprise stemless electrodes. The tubular wall 309 passes through the wall 324 of a glass housing 325 of the lamp such that part of the body 307 lies internal of the housing 325 and a part lies external to the housing 325. The external part of the wall 309 is connected to a power supply (not shown). Internal of the tubular body 307 is a glass wall 327 which connects to the stem of the carrier member and seals the interior of the housing 325 from the exterior.

The interior of the glass housing 325 is provided with a phosphor coating 327 and the housing 325 is evacuated and charged with a small quantity of mercury.

In use, the operation of the lamp is substantially the same as that of FIG. 4 and the reservoir performs in substantially the same manner as illustrated by FIGS. 3A-3C with sputtering causing active material to be released from the reservoir and that active material re-depositing on the inner surface of the electron emission source component 306 such that the life of the electron emission source component 306 may be extended.

In an alternative embodiment (not illustrated) a lamp is substantially as described in relation to FIG. 5 but comprises an electron emission source component comprising a tubular wall having a stem connected thereto. The stem extends through the wall of the housing such that the entirety of the tubular body lies internal to the housing.

It will be appreciated that electrode apparatus according to preferred embodiments of the present invention may be advantageous. In particular, they may be efficient to produce and may have enhanced lifetimes compared to known components.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An electrode apparatus comprising an emission source component having an emission surface comprising an active material and/or arranged to receive an active material and wherein the electrode apparatus further comprises a reservoir of active material for replenishing the active material of said source component emission surface and/or for providing an active material to said source component emission surface.

2. An electrode apparatus according to claim 1, wherein the apparatus comprises an emission source component having an emission surface comprising an active material and wherein the electrode apparatus further comprises a reservoir of active material for replenishing the active material of said source component emission surface.

3. An electrode apparatus comprising an emission source component comprising a tubular wall providing a hollow tubular body and having an inner emission surface comprising an active material and wherein the electrode apparatus further comprises a reservoir of active material for replenishing the active material of the tubular wall emission surface.

4. The electrode apparatus according to claim 3, wherein the reservoir comprises a carrier member arranged to obstruct but not fully close an end of the tubular body.

5. The electrode apparatus according to claim 3, wherein the reservoir comprises a closure member arranged to close an end of the tubular body such that the tubular body is blind at one end.

6. The electrode apparatus according to claim 3, wherein the tubular body comprises a tubular wall formed from a base material and which is coated with said active material.

7. The electrode apparatus according to claim 3 wherein the tubular body comprises a tubular wall formed from a base material and which is coated with said active material, and wherein the tubular body comprises a tubular wall comprising a base material selected from the group consisting of Steel (ferrous) alloys, Nickel (Ni), Molybdenum (Mo), Niobium (Nb), Tantalum (Ta) and Tungsten (W) or alloys and/or mixtures thereof and which is coated with said active material.

8. The electrode apparatus according to any of claim 3, wherein the tubular body comprises a tubular wall formed solely from said active material.

9. The electrode apparatus according to claim 3, wherein the reservoir comprises a closure member arranged to close an end of the tubular body such that the tubular body is blind at one end and wherein the closure member comprises a closure wall formed from a base material and which carries a quantity of active material to provide said reservoir.

10. The electrode apparatus according to claim 3 wherein the reservoir comprises a closure member arranged to close an end of the tubular body such that the tubular body is blind at one end and wherein the closure member comprises a closure wall formed from a base material and which carries a quantity of active material to provide said reservoir and wherein the closure member comprises a closure wall comprising a base material selected from the group consisting of Steel (ferrous) alloys, Nickel (Ni), Molybdenum (Mo), Niobium (Nb), Tantalum (Ta) and Tungsten (W) or alloys and/or mixtures thereof.

11. The electrode apparatus according to claim 3 wherein the reservoir comprises a closure member arranged to close an end of the tubular body such that the tubular body is blind at one end and wherein the closure member comprises a closure wall formed solely from said active material.

12. The electrode apparatus according to claim 3 wherein the reservoir comprises a closure member arranged to close an end of the tubular body such that the tubular body is blind at one end and wherein the closure member comprises a cap arranged to locate over the tubular wall.

13. The electrode apparatus according to claim 3 wherein the reservoir comprises a closure member arranged to close an end of the tubular body such that the tubular body is blind at one end and wherein the closure member comprises a plug arranged to locate within the tubular wall.

14. The electrode apparatus according to claim 3, wherein the active material comprises low work function material.

15. The electrode apparatus according to claim 3, wherein the active material comprises one or more of Molybdenum, Tungsten, Barium, Aluminum or Barium-Aluminum alloy.

16. The electrode apparatus according to claim 3, wherein, wherein the active material comprises an alloy comprising Barium and Mercury.

17. The electrode apparatus according to claim 3 wherein the tubular body has an outer diameter of between 0.5 and 5 mm and wherein the length of the tubular body is at least 5 times its diameter.

18. An electrode assembly comprising an electrode apparatus comprising an emission source component having an emission surface comprising an active material and/or arranged to receive an active material and wherein the electrode apparatus further comprises a reservoir of active material for replenishing the active material of said source component emission surface and/or for providing active material to said source component emission surface and a stem attached to the source component.

19. An electrode assembly according to claim 18, wherein the assembly comprises an electrode apparatus comprising an emission source component having an emission surface comprising an active material and wherein the electrode apparatus further comprises a reservoir of active material for replenishing the active material of said source component emission surface and a stem attached to the source component.

20. An electrode assembly according to claim 18, wherein the electrode apparatus comprises an apparatus comprising an emission source component comprising a tubular wall providing a hollow tubular body and having an inner emission surface comprising an active material and wherein the electrode apparatus further comprises a reservoir of active material for replenishing the active material of the tubular wall emission surface.

21. An electrical apparatus comprising an electrode apparatus according to claim 1.

22. An electrical comprising an electrode assembly according to claim 18.

23. A method of forming an electrode apparatus comprising an emission source component comprising a tubular wall providing a hollow tubular body and having an inner emission surface comprising an active material and wherein the electrode apparatus further comprises a reservoir of active material for replenishing the active material of the tubular wall emission surface wherein the method comprises producing a closure member comprising a reservoir of active material, forming an open ended tube comprising an inner surface comprising said active material, and securing the tube and an closure member to one another such that the closure member closes an end of the tube to provide a tubular body which is blind at one end.

24. The method according to claim 23, wherein the method comprises forming a closure member from a base material and applying a coating of active material thereto to provide said reservoir.

25. The method according to claim 23, wherein the method comprises applying a coating of active material to a metal sheet comprising a base material and bending the metal sheet to form said tube.

26. The method according to claim 23, wherein a stem is attached to the blind end of the tubular body such that an electrode is manufactured.

27-33. (canceled)
